(19) United States
(12) Patent Application Publication
(10) Pub. No.: US 2007/0020055 A1
(43) Pub. Date: Jan. 25, 2007

(54) Tool guide

(76) Inventor: Jeremy E. Ore, San Diego, CA (US)

Correspondence Address: PETER MARTINEZ, P.O. BOX 131313, CARLSBAD, CA, 92013-1313, US

(21) Appl. No.: 11/187,361

(22) Filed: Jul. 23, 2005

(51) Int. Cl. B23B 47/28

(52) U.S. Cl. 408/76

(57) ABSTRACT

A tool guide apparatus and method is provided. One embodiment of the invention includes a positioning block having an aperture into which a transparent aperture center indicator is placed. An activateable coupling member is coupled to the positioning block and rigidly couples the tool guide to a workpiece. The aperture center indicator is replaced with a tool receiver that includes an aperture for receiving a tool. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### FIELD OF THE INVENTION

The present invention generally relates to machining workpieces. More particularly, the invention concerns an apparatus, system and method to guide tools.

### BACKGROUND OF THE INVENTION

It is well known to drill and tap holes by hand. A great number of electric hand-held drills are in everyday use by both professional and amateur machinists and craftsmen. Similarly, hand-tapping threads into a workpiece is a common practice.

A major problem associated with hand drilling is that of producing a hole such that its longitudinal axis is perpendicular to the workpiece surface in which the hole is drilled. Jigs and fixtures are commonly used to guide drills in production operations used in industry. However, such jigs and fixtures are of little use in solving the hand drilling problems faced by home craftsmen or even by professional machinists. With hand operations, the person frequently must rely only on his eye to properly align the drill both before and during the drilling operation. Inaccurate holes are frequently the result.

The problems associated with hand tapping holes are at least as great as those associated with hand drilling. Even if the hole to be tapped is accurate, there is no assurance that the hole will be tapped in an acceptable manner. That is because, like a hand-held drill, a hand-held tap is also free to wander in space as it is rotated by the machinist. Unless the tap longitudinal axis is concentric with the hole longitudinal axis, the tap will break, or misaligned threads will be formed in the workpiece.

The tasks of manual drilling and tapping a hole exemplify the more general problem of aligning an essentially manual tool perpendicularly to a surface of an arbitrary workpiece. Various other tools such as punches, engravers, stamps, and bores may be operated manually but are often most effective when positioned perpendicular to the surface of the workpiece. It is especially problematic when the workpiece is large, immovable, marginally accessible, in an unusual or uncomfortable orientation, or otherwise not amenable to the use of traditional precision tools, such as a drill press.

Thus, a need exists for improvement in many manual tool operations requiring perpendicular application of the tool on the surface of a workpiece.

### SUMMARY OF THE INVENTION

The present invention provides a tool guide apparatus and method that ensures manually operated tools are applied perpendicularly to a flat, convex, concave, or other shaped surface of a workpiece. The tool guide may be used in conjunction with a variety of tools, including drill bits, hole taps, hole grinders, punches, stamps and inscribers.

One embodiment of the present invention provides a tool guide apparatus comprising a positioning member rigidly attached to a coupling member. The positioning member includes an aperture into which a tool receiver may be placed, and the coupling member employs a selectively activateable magnetic field. The operator positions the apparatus on a magnetically responsive (e.g., ferrous) workpiece so that the aperture of the positioning member is generally aligned with a desired reference point on the surface of the workpiece. A transparent visual alignment aid is inserted into the aperture of the positioning member and used to refine the position of the aperture with respect to the reference point, such that substantially exact alignment is achieved when the visual aid and the reference point are aligned. The magnetic field of the coupling member is then activated, causing the tool guide apparatus to be rigidly coupled to the surface of the workpiece. In the case where the workpiece is non-ferrous, a mounting plate, having ferrous properties, may be affixed to the workpiece.

The operator removes the visual alignment aid from the aperture in the positioning member and may then replace it with a tool receiver for a desired tool. Alternatively, a tool may be directly inserted into the aperture in the positioning member. If a tool receiver is employed, the desired tool is inserted into the tool receiver and, because of the previous alignment step, the tool is aligned with the reference point. In addition, substantial perpendicular orientation of the tool with respect to the workpiece surface, often an essential requirement of a task, is therefore achieved manually without resorting to the use of cumbersome jigs and avoiding the need for larger, fixed-base tools. When the task is completed, the coupling member is deactivated and the entire apparatus may be removed from, or repositioned elsewhere on the surface of the workpiece.

Other advantages of the present invention lie in its use of interchangeable tool receivers, allowing, for example, a variety of tools to be sequentially applied at a position on the workpiece surface following a single alignment. For example, for drilling and tapping a large hole, a small drill may be used to drill a pilot hole, then a larger drill may be employed, followed by a hole tap.

Another advantage of interchangeable tool receivers is that the aperture positioning member itself is not worn with use, because tools are received by the tool receivers, not the aperture itself. In addition, the tool receiver provides substantial support to a tool shank, thus ensuring precise perpendicular positioning of the inserted tool. The tool receiver may also be constructed from a non-ferrous material, thereby eliminating the common problem of metal chips adhering to a tool guide.

Another feature of the present invention is that the coupling member may be coupled to a workpiece oriented vertically, or to the underside of a workpiece, or generally to a workpiece not amenable to the application of traditional tools.

These and other features and advantages of the present invention will be appreciated from review of the following detailed description of the invention, along with the accompanying figures in which like reference numerals are used to describe the same, similar or corresponding parts in the several views of the drawings.

### BRIEF DESCRIPTION OF THE DRAWINGS

Various embodiments of the present invention taught herein are illustrated by way of example, and not by way of limitation, in the figures of the accompanying drawings, in which:

FIG. 1 is an illustration of an embodiment of the present invention, coupling to a surface of a workpiece;

FIG. 2 is an illustration depicting alignment of the aperture center indicator with a reference point marking on the surface of a workpiece;

FIG. 3 is an illustration depicting the relationship of an aligned tool receiver with a reference point marking on the surface of a workpiece; and

FIG. 4 is a flow diagram illustrating one method of practicing the present invention.

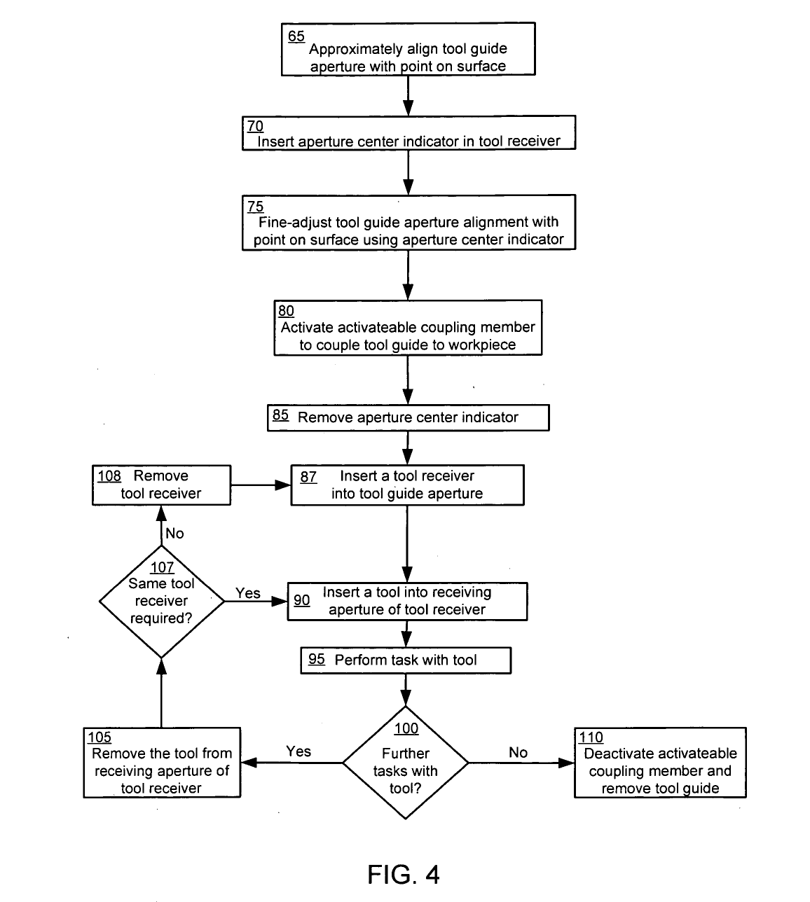

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following paragraphs, the present invention will be described in detail by way of example with reference to the attached drawings. While this invention is capable of embodiment in many different forms, specific embodiments are shown in the drawings and will herein be described in detail with the understanding that the present disclosure is to be considered as an example of the principles of the invention and not intended to limit the invention to the specific embodiments shown and described. That is, throughout this description, the embodiments and examples shown should be considered as exemplars, rather than as limitations on the present invention. Descriptions of well known components, methods and/or processing techniques are omitted so as to not unnecessarily obscure the invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention provides an apparatus and method of locating one or more tools, such as a drill bit or a tap, in a desired location on a workpiece. In one embodiment, the present invention provides a tool guide that locates a first tool at a desired location on a workpiece surface and aligns it perpendicularly to the surface. If desired, subsequent tools may then also be so located by the present invention, thereby ensuring that the subsequent tools are longitudinally aligned with the results the prior tool. For example, an operator may locate and align a drill bit at a target spot on a workpiece, drill a hole, and then remove the drill and apply a tap, thus retaining the same position and alignment for the second tool.

One feature of the present invention is that it enables a tool to be applied exactly at a desired location on a workpiece surface, and the longitudinal axis of the tool will be substantially perpendicular to the surface. The workpiece may be positioned in virtually any orientation. The coupling action of the invention couples the invention to any workpiece surface, regardless of the orientation of the workpiece.

Another feature of the present invention is that because the tool receivers provided in the invention are interchangeable, a variety of tool sizes and types may be used. Moreover, tool receiver interchangeability also provides that worn tool receivers may be replaced separately, with no requirement to replace the entire tool guide apparatus.

The present invention is effective on flat workpiece surfaces as well as those comprising convex and/or concave surfaces.

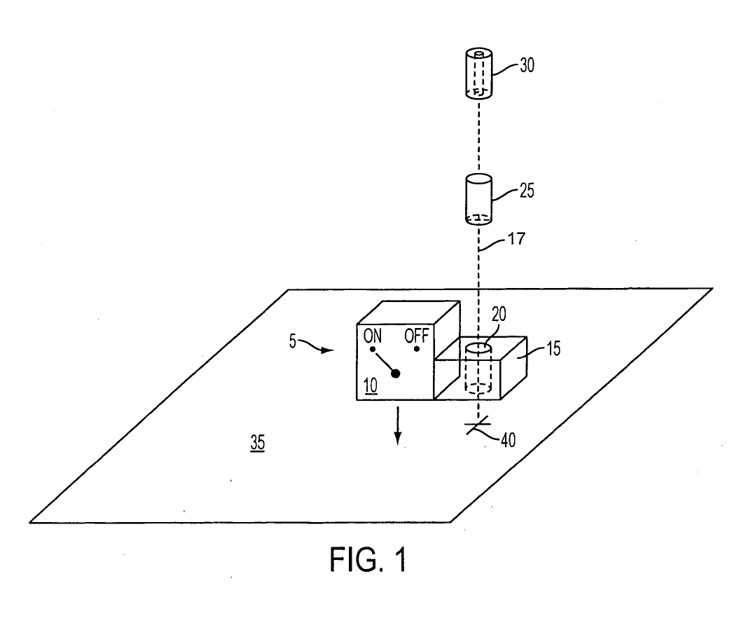

FIG. 1 illustrates a preferred embodiment of the present invention, comprising the tool guide 5, as it is applied to a workpiece 35. The activateable coupling member 10 functions to couple the tool guide 5 rigidly to a surface of the workpiece 35. The workpiece 35 shown in FIG. 1 is depicted in a level orientation, but the coupling member 10 is capable of coupling the tool guide 5 to the workpiece 35 with equivalent effectiveness when the workpiece 35 is in vertical, inverted, or other intermediate orientations thereof. The workpiece 35 is also depicted as having a flat surface, but it will be appreciated that the workpiece may have any shape. The present invention is capable of operating upon many types of surfaces, including flat, convex, and concave surfaces.

In this embodiment of the invention, the activateable coupling member 10 comprises a magnetic base equipped with an ON-OFF switch for activation and deactivation. In the ON position, internal magnets align to create a magnetic field and cause the activateable coupling member 10 to couple to the workpiece 35, which in this embodiment is magnetically attractive. It will be appreciated that the magnetic base comprising the activateable coupling member 10 is well known and commonly available. Typical applications for magnetic bases include, for example, flexible supports for dial indicators. For these applications, a main pole is typically screwed into the top of the magnetic base, to which other rigid and/or flexible articulating subpoles are clamped to effect a holding stand for various attachments. The magnetic has a “V” cut into its coupling surface to facilitate coupling to convex surfaces such as a tube. The magnetic base may also couple to concave surfaces such as a rounded trough. These devices are generally referred to as “magnetic bases,” “micromanipulators,” “magnetic holding stands,” and “holding devices.” Known manufacturers of these magnetic bases and attachments include OptoSigma of Santa Clara, Calif., and Eclipse Magnetics of Sheffield, England. It will be appreciated to those skilled in the art that alternatives and equivalents to the activateable magnetic base exist. These alternatives include coupling means such as clamps, suction devices and other equivalent devices. These alternatives may be employed when the workpiece 35 is made of non-ferrous material. Alternatively, the activateable magnetic base may be employed in conjunction with a ferrous mounting plate, or device, that is coupled to the workpiece 35. For example, a slotted ferrous plate may be clamped to a non-ferrous workpiece 35, enabling the activateable magnetic base to be magnetically coupled to the slotted ferrous plate.

As illustrated in FIG. 1, a positioning member 15 is rigidly attached to the activateable coupling member 10. The positioning member 15 may also be removeably attached to the activateable coupling member 10, so as to allow replacement when necessary. A tool guide aperture 20 is provided in the positioning member 15. In this embodiment of the present invention, the positioning member 15 is positioned with respect to the activateable coupling member 10 so that the longitudinal axis 17 of the tool guide aperture 20 is substantially perpendicular to the surface of the workpiece 35, when the activateable coupling member 10 is activated. In other embodiments of the present invention, the positioning member 15 may be attached to the activateable coupling member 10 to provide any desired angle, or orientation of the longitudinal axis 17 of the tool guide aperture 20 relative to the surface of the workpiece 35.

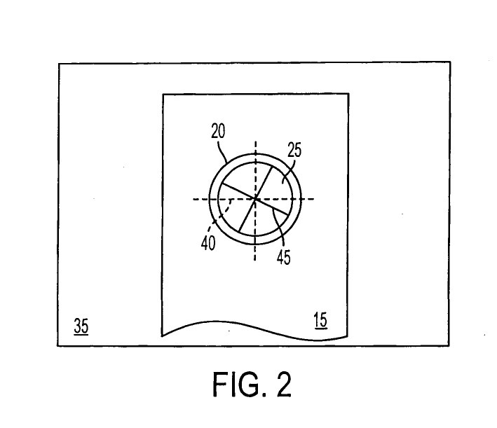

As shown in FIG. 2, one feature of the present invention is that it enables substantially exact alignment of a tool with respect to a reference point 40 on the surface of the workpiece 35. An initial, approximate alignment is performed by positioning the tool guide 5 such that the reference point marking 40 is visible when viewed through the tool guide aperture 20. An aperture center indicator 25 is then inserted into the tool guide aperture 20 and used to further position the tool guide 5 such that the reference point marking 40 is aligned substantially exactly with the center of the tool guide aperture 20.

Referring to FIG. 2, an aperture center indicator 25 is shown located in the tool guide aperture 20. The aperture center indicator 25 comprises a solid cylinder made of a clear material, such as glass or acrylic, for example, which includes a visual aid 45 inscribed on one end of the cylinder. It will be appreciated that the visual aid 45 may be “cast in” to the visual aid 45. In the illustrated embodiment, the visual aid 45 is a cross-hair that marks the exact cross-sectional center of the aperture center indicator 25. It will be appreciated that the visual aid 45 may include other types of references, such as a series of circles, with a “bulls eye” at the center of the circles. When looking through the aperture center indicator 25, the visual aid 45 is visible. When the aperture center indicator 25 is placed in the tool guide aperture 20, the reference point marking 40 inscribed on the surface of the workpiece 35 is visible through the aperture center indicator 25. With both the reference point marking 40 and the visual aid 45 thus visible through the aperture center indicator 25, the tool guide 5 may be finely positioned so as to substantially align the reference point marking 40 and the visual aid 45 relative to each other.

FIG. 2 depicts an example of an operator's view when the center of the visual aid 45 crosshair is substantially exactly aligned with the center of the reference point marking 40 crosshair. It will be appreciated that markings other than a crosshair may comprise the reference point marking 40 or the visual aid 45, with no loss of effectiveness. An embodiment of the present invention further provides an illuminating effect in the aperture center indicator 25, depending upon the type of clear material from which it is made and its capability for gathering and channeling light, thereby enhancing the operator's view of the reference point marking 40 and the visual aid 45. Once exact alignment between the visual aid 45 and the reference point marking 40 is achieved, the operator activates the activateable coupling member 10 to rigidly couple the tool guide 5 to the surface of the workpiece 35.

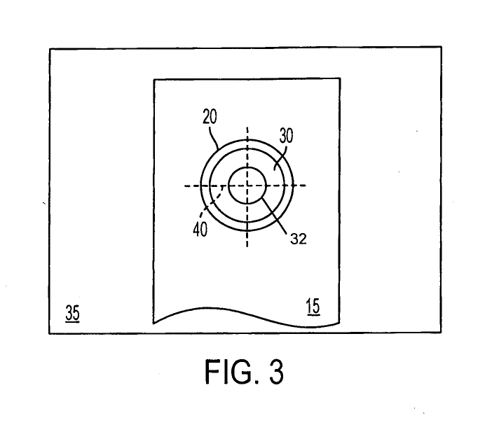

Referring now to FIGS. 1 and 3, which depict a tool receiver 30. With the tool guide 5 rigidly coupled to the surface of the workpiece 35, the aperture center indicator 25 is removed from the tool guide aperture 20 and replaced by a tool receiver 30. FIG. 3 illustrates an operator's view of a tool receiver 30 placed in the tool guide aperture 20, and the reference point marking 40 visible through the tool receiver aperture 32 located in the tool receiver 30. After insertion into the tool guide aperture 20, the tool receiver 30 assumes the substantially exact alignment with the reference point marking 40 achieved using the aperture center indicator 25. A tool of any desired size, or diameter may then be placed into the tool receiver aperture 32 and applied to the surface of the workpiece 35 at the location of the reference point marking 40 and substantially perpendicular to the surface of the workpiece 35. Further, the tool receiver 30 may be structured to have a longitudinal length (i.e., height or depth, as shown in FIG. 1) such that the shank of the inserted tool is sufficiently supported to ensure stable orientation during operation.

One feature of the present invention is that different tool receivers 30 may be provided, with each tool receiver 30 having a different diameter tool receiver aperture 32, each sized to receive different diameter tools. A tool positioned in the tool receiver aperture 32 will be oriented substantially perpendicularly to the surface of the workpiece 35 and substantially exactly in the desired location designated by the reference point marking 40. Further, by removing the tool receiver 30 and replacing it with other tool receivers 30 that may have different diameter tool receiver apertures 32, other tools may be applied in the same orientation and at the same location on the surface of the workpiece 35. For example, a first tool applied to the workpiece could be a drill. A second tool comprising a threaded tap may be applied using the same tool receiver 30 used for the drill. Advantageoulsy, the tap will also be oriented perpendicular to the workpiece 35, and positioned over the reference point 40. Other tools, such as a countersink or deburring tool, may also be applied, the operation of each tool similarly benefiting from the guidance of the tool receiver aperture 32 with respect to orientation and position on the workpiece 35.

FIG. 5 is a flow diagram illustrating steps of practicing the present invention. In this embodiment of the present invention, the first step 65 comprises positioning a tool guide 5 on a surface of a workpiece 35 such that the tool guide aperture 20 is approximately aligned with a desired reference point marking 40 on the surface. In step 70, the aperture center indicator 25 is then inserted into the tool guide aperture 20. In step 75, alignment of the tool guide aperture 20 relative to the reference point marking 40 is fine-adjusted by positioning the visual aid 45 (located on the aperture center indicator 25) cross-hairs with the reference point marking 40. Once alignment is achieved, in step 80 an activateable coupling force is activated, thus rigidly coupling the tool guide 5 to the surface of the workpiece 35.

In step 85, the aperture center indicator 25 is removed from the tool guide aperture 20. In step 87, a tool receiver 30 is next inserted into the tool guide aperture 20, the tool receiver 30 having an appropriate diameter to receive a desired tool. In step 90, the desired tool is inserted into the tool receiver aperture 32. In step 95, a first task is performed with the tool. When the first task is completed, in step 100 a determination is made as to other tasks. If no other tasks are to be performed, then in step 110 the activateable coupling member 10 is deactivated and the tool guide 5 is removed from the workpiece 35.

Alternatively, if after the first task is completed there are further tasks to be performed, in step 105 the tool is removed from the tool receiver aperture 32. In step 107, a determination is made as to the tool, and tool receiver 30 required for the next task. If the desired tool for the subsequent task to be performed requires the current tool receiver 30, then the desired tool is inserted into tool receiver aperture 32, and the next task is performed with the tool. If, however, the desired tool for the subsequent task requires a different tool receiver 30, then in step 108, the current tool receiver 30 is removed from the tool guide aperture 20. A new tool receiver 30 is then inserted into the tool guide aperture 20, the tool receiver 30 having been selected to properly receive a desired tool anticipated for use in the subsequent task.

The desired tool is then inserted into tool receiver aperture 40. The subsequent task is performed then performed with the tool. When the subsequent task is completed, if there are no further tasks to be performed with other tools while the tool guide 5 is coupled in the current position, then the activateable coupling member 10 may be deactivated and the tool guide 5 removed from the surface of the workpiece 35. If after the subsequent task is completed there are further tasks to be performed with other tools, then the applicable steps described above to remove and replace the current tool receiver 30 or tool are repeated.

An example application of the method described above follows. Once the tool guide 5 is aligned with a reference point marking 40 and coupled to the surface of the workpiece 35 by activating the activateable coupling member 10, a first task comprising drilling a hole into the workpiece 35 may be performed. After removing the aperture center indicator 25, a tool receiver 30 having an tool receiver aperture 20 sized to accommodate a desired drill bit is inserted into the tool guide aperture 20, followed by insertion of the desired drill bit, which is driven by a drill motor. The drill may then be activated to produce a hole in the workpiece 35 at the substantially exact position, and substantially perpendicular to the reference point marking 40. Rigid coupling of the tool guide 5 to the workpiece prevents the drill bit from wandering during the drilling operation. Substantially perpendicular orientation of the drill bit to the surface of the workpiece 35 is also ensured. The drill bit may then be removed from the tool receiver aperture 32 and a subsequent task comprising threading the hole to accept a screw may be performed. A threaded tap is inserted into the tool receiver aperture 32, whereupon the hole may be threaded by operating the tap. The tap retains the exact position and vertical orientation as the drill bit before it, ensuring a properly formed thread in the hole. When the tapping operation is complete, a further subsequent task comprising countersinking (i.e., beveling) the top of the hole to accept, for example, a Phillips head screw may be performed. The tap and the tool receiver 30 are removed from the tool guide aperture 20. The current tool receiver 30 is not appropriately sized for the countersinking tool, so a different tool receiver 30 is required. The current tool receiver 30 is removed from the tool guide aperture 20 and a desired tool receiver 30 is inserted therein, the tool receiver 30 having a tool receiver aperture 32 sized to accept a desired countersinking tool. The desired countersinking tool is inserted into the tool receiver aperture 32 and operated to produce the desired bevel at the top of the hole. When the beveling task is completed, and no further tasks with other tools are required, the entire tool guide 5 apparatus may be quickly removed from the workpiece 35 by deactivating the activateable coupling member 10 by selecting the OFF position.

Thus, the present invention can enable a sequence of tasks comprising: drilling a perpendicular hole at exactly a desired location on a workpiece; precisely threading the hole; and countersinking the hole.

Unless defined otherwise, all technical and scientific terms used herein have the same meaning as is commonly understood by one of skill in the art to which this invention belongs. In event the definition in this section is not consistent with definitions elsewhere, the definitions set forth in this section will control.

As used herein, “transparent” or “substantially transparent” refers to a material characteristic that allows the passage of a sufficient amount of light to allow a person looking through the material to view objects under normal working conditions.

The term “couple,” as used herein, is defined as “to connect,” although not necessarily directly, and not necessarily mechanically.

As used herein, “aperture” refers to an opening or hole including, but not limited to, a circular hole, a slotted hole, an elongated hole, and a channel hole.

Thus, it is seen that an apparatus, system and method of guiding a tool is provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

What is claimed is:

1. A tool guide, comprising:
a first activateable coupling member, the activateable coupling member structured to selectively produce a magnetic field; and
a positioning block coupled to the activateable coupling member, the positioning block including a tool guide aperture.

2. The tool guide of claim 1, further comprising at least one tool receiver sized to be received in the tool guide aperture, the tool receiver including an aperture sized to receive a tool.

3. The tool guide of claim 1, wherein the tool is selected from a group consisting of: a drill, a tap, a punch, a marker, a stain applicator, a paint applicator, an inscribing tool, a bore, a piercing tool, a stamp, an engraving tool, a grinding tool, a cutting tool, an etching tool, a soldering tool, and a welding tool.

4. The tool guide of claim 2, where the tool receiver comprises a non-ferrous material.

5. The tool guide of claim 1, further comprising a centering member comprising a substantially transparent element that includes an aperture center indicator.

6. The tool guide of claim 5, where the aperture center indicator comprises a visual aid selected from a group consisting of: a line, two substantially perpendicular, intersecting lines, two non-perpendicular intersecting lines, a point, a cross, an X, and a series of circles.

7. The tool guide of claim 1, further comprising a mounting plate comprising a magnetically attractive material, the mounting plate including at least one aperture selected from a group consisting of: a circular hole, a slotted hole, an elongated hole, and a channel-shaped hole.

8. A tool guide, comprising:
a first activateable coupling member;
a positioning block coupled to the activateable coupling member, the positioning block including a tool guide aperture; and
at least one tool receiver sized to be received in the tool guide aperture, the tool receiver including an aperture sized to receive a tool.

9. The tool guide of claim 8, wherein the activateable coupling member is selected from a group consisting of: a magnetic coupler, an electromagnetic coupler, a suction clamp, and a mechanical clamp.

10. The tool guide of claim 8, wherein the tool is selected from a group consisting of: a drill, a tap, a punch, a marker, a stain applicator, a paint applicator, an inscribing tool, a bore, a piercing tool, a stamp, an engraving tool, a grinding tool, a cutting tool, an etching tool, a soldering tool, and a welding tool.

11. The tool guide of claim 8, further comprising a centering member comprising a substantially transparent element that includes an aperture center indicator.

12. The tool guide of claim 11, where the aperture center indicator comprises a visual aid selected from a group consisting of: a line; two substantially perpendicular lines; two non-perpendicular lines; a point; a cross, an X, and a series of circles.

13. The tool guide of claim 8, further comprising a mounting plate comprising a magnetically responsive material, the mounting plate including at least one aperture selected from a group consisting of: a circular hole, a slotted hole, an elongated hole, and a channel-shaped hole.

14. The tool guide of claim 8, further comprising a second activateable coupling member coupled to the positioning block, and located substantially opposite to the first activateable coupling member.

15. A method of orienting a tool relative to a reference point on a workpiece, the method comprising the steps of:
positioning a receiving aperture of a tool guide adjacent to the reference point;
inserting an aperture center indicator into the receiving aperture; and
repositioning the tool guide to substantially align the aperture center indicator with the reference point.

16. The method of claim 15, further comprising the step of:
activating a coupling force to substantially couple the tool guide to the workpiece.

17. The method of claim 16, further comprising the steps of:
removing the aperture center indicator from the receiving aperture; and
inserting a tool receiver into the receiving aperture.

18. The method of claim 17, further comprising the step of:
inserting at least one tool into a receiving aperture in the tool receiver.
